(19) United States
(12) Patent Application Publication
(10) Pub. No.: US 2001/0054102 A1
(43) Pub. Date: Dec. 20, 2001

(54) Login method for identifying devices on a network

(76) Inventor: Jeffery J. Kacines, Allen, TX (US)

Correspondence Address: TEXAS INSTRUMENTS INCORPORATED, P O BOX 655474, M/S 3999, DALLAS, TX, 75265

(21) Appl. No.: 09/842,942

(22) Filed: Apr. 26, 2001

Related U.S. Application Data
(60) Provisional application No. 60/206,676, filed on May 24, 2000.

(51) Int. Cl. G06F 15/173

(52) U.S. Cl. 709/226

(57) ABSTRACT

A method of logging in new devices to a network. Each device stores a unique device identification number. A network controller performs the login process by sending and receiving patterns of requests and acknowledgements. It uses the acknowledgements to traverse a binary tree, and thereby “learn” the device identification number of a new device.

### TECHNICAL FIELD OF THE INVENTION

This invention relates to communications networks, and more particularly to a method for logging in devices to the network.

### BACKGROUND OF THE INVENTION

All networks rely on some form of addressing the devices connected in it. For example, for many networks, a packet is the basic unit used to send data over a network connection. Each packet contains not only the data to be transmitted but also the information needed to get the packet to its destination and to reconstitute it with other packets into the original data. Thus, the network must have some form of addressing, that is, a means by which every device on the network can be uniquely identified.

Some addressing schemes depend on explicitly providing the network with the device identifier. This approach is used in ethernet networks. An alternative approach is to implement a signal blocking scheme to limit communications to one device at a time during network initialization. This approach is used for USB devices.

### SUMMARY OF THE INVENTION

One aspect of the invention is a method of logging in a device to a network of devices. Each device stores an identification number unique to that device. A network controller first delivers a control code to each device on the network indicating that a login process is to begin. The controller then broadcasts a pattern of requests and receives acknowledgements from devices attempting to login. The requests inquire as to the value of successive bit positions of the devices' identification numbers, and the pattern of requests varies depending on which requests are acknowledged. The controller traverses a binary tree in response to acknowledgements, thereby determining the identification number of the device.

One advantage of the invention is that it eliminates the need to provide unique identifiers to the network prior to adding a device to the network. All that is required is for the device itself to store its own identifier—the network “learns” the identifier by means of the login process without having to actually address the device. This is accomplished without signal blocking schemes.

### BRIEF DESCRIPTION OF THE DRAWINGS

FIG. 1 illustrates a network performing a login process in accordance with the invention.

FIG. 2 illustrates the sequence of requests broadcast by the network controller of FIG. 1.

FIG. 3 illustrates the binary tree traversed by the controller during the login process.

FIG. 4 illustrates the timing of requests and acknowledgements.

### DETAILED DESCRIPTION OF THE INVENTION

FIG. 1 illustrates a network 10 performing a login process in accordance with the invention. As explained below, the login process is a binary search algorithm (BSA) process, which permits a device 11 to join network 10 without the need to load a device identifier other than to the device itself. In other words, it is required only that each device 11 store its own identifier.

Network 10 may be any data communications network, comprised of a number of devices 11 that are typically processor-based. Each device 11 is in data communication with a network controller 12.

Network 10 may be a computer network, where each device 10 is a computer workstation and controller 12 is a server computer that manages network resources. Or, network 10 could be a calculator network, where each device 10 is a hand-held calculator and controller 12 is a hardware device for communications control. These are but two examples of networks with which the invention may be used. The communications links in the network 10 may be wired, wireless, or some combination of these two media.

In general, the invention is useful for any network 10 of devices in data communication with each other and with a controller 12. The processing resources of the devices 11 and the controller 12 are at least such that they are capable of performing the functions described herein. Typically, both devices 11 and controller 12 are processor based and have appropriate memory for storing programming for the processor. However, other processing means, such as programmable logic devices, may be used to send and receive messages, store data, and maintain registers in the manner described herein. For either the devices 11 or the controller 12, the login tasks could be implemented with dedicated circuitry apart from other processing tasks, or it could be performed by other general purpose processing resources.

As illustrated, each device 11 is assigned a unique ID number, which it stores in memory 11a. For simplicity of example herein, the ID numbers of FIG. 1 have only 3 bits. A first device has ID number 001, a second has 010, a third has 011, and a fourth has 110. Each device 11 also has a tracking register 11b, which tracks identification request signals received from controller 12 during the login process.

The login process of FIG. 1 may be performed any time it is desired to determine whether a new device 11 connected to network 10 and is attempting to login. The login process permits that device 11 to be identified and to be assigned a network address. This in turn, permits the device to send and receive data via the network. In a typical network 10, controller 12 will initiate the login process periodically, with the frequency being related to the likelihood that new devices 11 are being added. For example, in a quickly changing network, controller 12 might initiate a new login process once every few seconds. Devices 11 that have not yet logged in a programmed to wait for a login initialization code, and to then receive requests and deliver acknowledgements as described below.

The ID number stored in each device 11 need not be its address for network purposes. In other words, once a device 11 is logged in, the device may be assigned a dynamic address. Network communications may then proceed in accordance with standard network protocol.

General Login Process

The login process is initiated when controller 12 sends out a login initialization code, indicating that a login process is to begin. Once this code is received, each device 11 expects to receive a series of request messages from controller 12.

Communications from server/controller 12 to devices 11 are “broadcast”. In other words, each device 11 receives the same signal at substantially the same time.

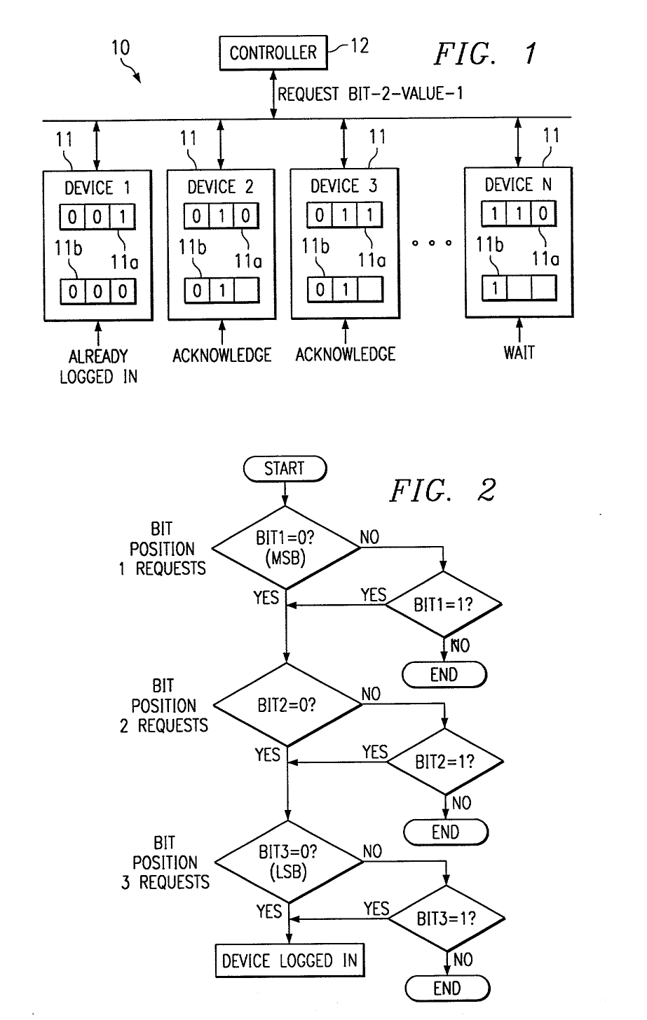

FIG. 2 illustrates a pattern of requests that are broadcast from controller 12 during the login process. The request pattern of FIG. 2 assumes a 3-bit device ID.

The first request from controller 12 queries for the value of a first bit position of device IDs. In the example of FIG. 2, the request is a request to any device 11 to acknowledge if its MSB (most significant bit) is 0. In other embodiments, the request order could be reversed such that the LSB (least significant bit) is the subject of the first request. Also, the order of the bit values could be reversed, such that the first request is for values of 1 rather than 0.

After a predetermined time, those devices having a 0 as the MSB of their stored ID number respond to the request. If no devices respond in that time, controller 12 assumes that there is no device attempting to login that has a 0 in the MSB of its ID number.

Referring again to FIG. 1, Device 1 and Device 2, which have ID numbers of 001 and 010, respectively, acknowledge the first request. Device 3 and Device 4 do not acknowledge the query. Device N does not have a 0 as its MSB. Device 3 has already logged in.

Referring to both FIGS. 1 and 2, if there is an acknowledgement to the first request, controller 12 sends a next request to determine whether any device is attempting to login that has a 0 in the next significant bit of its ID number. If there is no acknowledgement to the first request, the next request from server/controller 12 is to determine whether any devices are attempting to login that have a 1 as the MSB.

If any two successive requests are not acknowledged, the login process ends. So long as acknowledgements are received for either a 0 or 1 in a given bit position, the login process continues to the next bit position.

The process continues until the LSB is reached. At this point, there can be only one device 11 attempting to login.

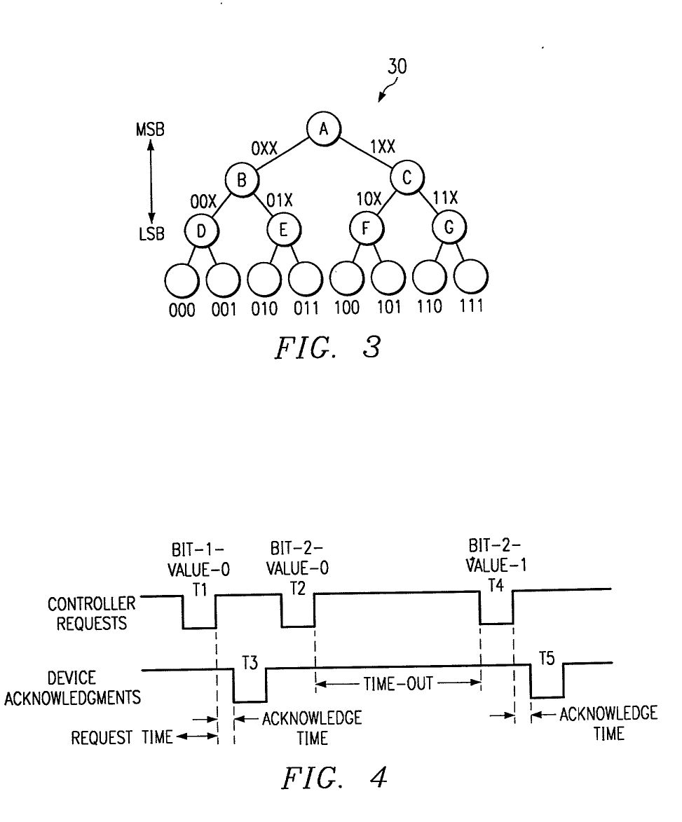

As explained below in connection with FIG. 3, the acknowledgements received by controller 12 permit it to traverse a binary tree. Using this tree, it determines the identification number of a device 11 that is attempting to login. Once the device is identified, it is logged in. The login process may be repeated immediately or after a predetermined interval to determine if additional devices are attempting to login.

During the login process, each device 11 updates the contents of its tracking register 11b and maintains a pointer to a bit position in the register. At initialization of the login process, each register 11b is cleared and the pointer points to the MSB, as the “current” bit. The register 11b is modified under two conditions. The first condition is when a single request signal is followed by an acknowledgement from any device. The current bit of the register is not changed and the pointer is incremented. The second condition is when two requests occur prior to an acknowledgement. This signal pattern indicates that controller 12 did not receive an acknowledgement for its first request and therefore the current bit is 1. The current bit of the register 11b is changed from 0 to 1 and the pointer is incremented to the next bit position.

The determination by any device 11 of whether other devices 11 have send acknowledgements can be handled in several ways. If a particular device 11 is itself acknowledging, it need not know if other devices are acknowledging. However, if a device 11 is not acknowledging, it can listen for acknowledgements of other devices. The determination could also be timing based. For example, a device that receives two requests within a period of time less than the timeout period could assume that another device sent an acknowledgement. The determination could also be accomplished by using controller 12 to echo acknowledgements.

During the login process, each device 11 monitors its register 11b and compares the contents of the register to its stored ID number. As long as there is a match, the device continues to acknowledge requests and continues to use its register 11b to track the ID number being built. As soon as there is a mismatch, the device no longer acknowledges requests. It will be logged in on a subsequent login cycle. As an alternative to a tracking register 11b, controller 12 could send out the device ID being built with each request, so that each device 11 simply compares the received bits with the appropriate bits of its stored device ID.

FIG. 3 illustrates an example of the binary tree 20 traversed by controller 12 during the login process. The root node, Node A, and divides the tree into two paths. The left path is for ID numbers having 1 as the MSB. The right path is for ID numbers having 0 as the MSB. Each node corresponds to a bit position. As each racknowledgement is received, controller 12 follows the appropriate path under the current node. A unique device ID is determined at the bottom of the tree.

FIG. 4 illustrates an example of the request signals sent by controller 12 and the acknowledge signals it receives. It is assumed that controller 12 has already delivered, to each device 11, appropriate control signals to indicate that the login process is to begin.

For purposes of FIG. 4, the request and acknowledge signals are one-bit signals with a value of 0. However, any coding scheme could be used. A feature of the invention is that requests and acknowledgements need not carry information. In other words, any signal indicating a response is sufficient. Thus, if more than one device 11 sends an acknowledgement, even a noisy acknowledgement is acceptable.

At time T1, controller 12 broadcasts a first request signal, which requests acknowledgement from any device 11 having a MSB of 0 in its ID number.

At time T2, each device 11 having a MSB of 0 sends an acknowledge signal. Timing is controlled so that all acknowledgements are received at controller 12 within a predetermined acknowledge time. By comparing its tracking register 11b to its device ID stored in memory 11a, any device 11 not having a MSB of 0 knows that it will not login on this cycle, so it need not further track the request signals.

Because at least one device 11 has sent an acknowledgement to the Bit-1-Value-0 request, controller 12 begins traversal of the left branch of tree 30 under the Node A.

If there had been no response to the request at T1, the next request would have been a Bit-1-Value-1 request for acknowledgement from devices 11 with a 1 in the MSB. If there were a response to this request, controller 12 would have begun to traverse the rightmost branch of tree 30 under Node A. If there were no response to this Bit-1-Value-1 request, then there could be no devices attempting to login and controller 12 would cease the login process.

At time T3, controller 12 sends a Bit-2-Value-0 request, which requests acknowledgement from any devices 11 having 0 in the second most significant bit. Devices 11 who did not respond to the first query (who do not have a 0 in the MSB) will not respond to this request, nor will devices 11 who have a 1 in the second most significant bit. Because no devices are attempting to login that have an ID number of 00×, controller 12 gets no acknowledgement.

At time T4, because there was no acknowledgement to the Bit-2-Value-0 request, controller 12 sends a Bit-2-Value-1 requests, which requests acknowledgement from devices 11 having 1 in the second most significant bit.

At time T5, the devices 11 with the ID number of 01x responds to the most recent request. Although not shown in FIG. 4, the process continues until controller 12 determines that it is at the bottom of tree 30 and that it has uniquely identified Device 2, having the device ID 010, which is attempting to log in. It can now send a logical address to that device.

As indicated above, it is possible for more than one device 11 to send an acknowledgement at the same time. For example, after the request at T1, the devices having the addresses 010 and 011 might both send an acknowledgement. At that time, both tracking registers 11b will so far match the request signals. However, after the next request, only one device will respond and have a tracking register 11b that matches its device ID number. The non responding device will have a tracking register 11b that no longer matches its ID number and will cease attempting to login for that cycle. It will attempt to login on a subsequent cycle.

As further indicated above, if controller sends out two consecutive requests without a response, it returns to the root node. For example, if there had been no acknowledgement after the request at T4, it would be determined that no device with the ID number of 01× was attempting to login.

Duration of the Login Process

The time required for controller 12 to identify a device ID is directly related to the maximum size of the device ID. Each request/acknowledge sequence cuts the possible device ID in half.

If the maximum size of the device ID is given by:

MaxID=2ⁿ

then n request/acknowledge sequences are required to identify a device ID. The maximum time required to determine a device ID is calculated as follows:

Max ID Time=n*[timeout time+request time+ack time]

This maximum time occurs for a device ID of 1111 . . . . The minimum time required to identify a device ID is calculated as follows:

Min ID Time=n*[request time +ack time]

This minimum time occurs for a device ID of 0000 . . . .

Referring again to FIG. 4, the above time parameters are defined as follows:

timeout time=the time required for the controller 12 to determine that there is no acknowledgement to request

request time=the time for a request from the controller 12 including propagation delays

ack time=the time of an acknowledgement from one or more devices 11 including propagation delays

As an example, assume the following network parameters: 10 microsecond request and acknowledge times, 100 microsecond timeout times and 10 digit hexadecimal device IDs. The time required to identify a device ID would be calculated as follows:

Max ID=16¹⁰=2⁴⁰

n=40

Min ID Time=40*[10 us+10 us]=800 us

Max ID Time=40*[100 us+10 us+10 us]=4.8 ms

The minimum time would occur for device ID 0×0000000000. The maximum time would occur for device ID 0×FFFFFFFFFF.

Other Embodiments

Although the present invention has been described in detail, it should be understood that various changes, substitutions and alterations can be made hereto without departing from the spirit and scope of the invention as defined by the appended claims.

What is claimed is:

1. A method of logging in a device to a network of devices, comprising the steps of:
storing, in each device, an identification number unique to that device, the identification number having a number of bits, each having a bit position;
delivering a control code to each device on the network indicating that a login process is to begin;
broadcasting a pattern of requests to all devices, each request representing a request to each device to acknowledge whether a given bit position of its identification number has a given binary value;
receiving acknowledgements from the devices; and
traversing a binary tree in response to acknowledgements, thereby determining the identification number of the device.

2. The method of claim 1, wherein the network is a wireless network and the broadcasting and receiving steps are performed with wireless signals.

3. The method of claim 1, wherein the network is a network of calculators.

4. The method of claim 1, wherein the network is a local area network of computers.

5. The method of claim 1, wherein the method is performed by a hardware logic device.

6. The method of claim 1, wherein the method is performed by a processor-based device.

7. The method of claim 1, wherein the first request is a request to acknowledge a one rather than a zero, and wherein the second request is a request to acknowledge a zero rather than a one.

8. The method of claim 1, wherein the acknowledgement is any signal above a noise threshold.

9. The method of claim 1, further comprising the step of maintaining a tracking register associated with each device to track acknowledgements.

10. The method of claim 1, wherein each device ceases to send acknowledgements for subsequent bit positions after it cannot acknowledgement with respect to any bit position.

11. The method of claim 1, further comprising the step of ending the login process if two successive requests for values of the same bit position are not acknowledged.

12. A method of logging in a device to a network of devices, comprising the steps of:
storing, in each device, an identification number unique to that device, the identification number having a number of bits, each having a bit position;
delivering a control code to each device on the network indicating that a login process is to begin;
broadcasting a first request to all devices, the first request representing a request to each device to acknowledge whether the first bit position of its identification number has a zero;
receiving acknowledgements from the devices in accordance with the following steps:
if an acknowledgement to the first request is received, repeating the broadcasting step for the next bit position of the identification number;
if no acknowledgement to the first request is received broadcasting a second request to all devices, the second request representing a request to each device to acknowledge whether the first bit of its identification number is a one; and if an acknowledgement to the second request is received, repeating the first broadcasting step for the next bit position of the identification number; and if no acknowledgement to the second request is received, ending the login process;
repeating the broadcasting and receiving steps for each bit position of the identification number; and
traversing a binary tree in response to acknowledgements, thereby determining the identification number of the device.

13. A network controller for login in a device to a network of devices, comprising:
processing circuitry for performing the following tasks:
delivering a control code to each device on the network indicated that a login process is to begin;
broadcasting a pattern of requests to all devices, each request representing a request to each device to acknowledge whether a given first bit position of its identification number has a given binary value;
receiving acknowledgements from the devices; and
traversing a binary tree in response to acknowledgements, thereby determining the identification number of the device.

14. The controller of claim 13, wherein the processing circuitry is a programmable logic device.

15. The controller of claim 13, wherein the processing circuitry is a processor and program memory.

16. The controller of claim 13, wherein the network is a local area network of computers, and the controller is part of a network server.

17. The controller of claim 13, wherein the network is a network of calculators, and the controller is a hardware communications controller.
